(19) United States
(12) Patent Application Publication
(10) Pub. No.: US 2011/0019889 A1
(43) Pub. Date: Jan. 27, 2011

(54) System and method of applying anatomically-constrained deformation

(76) Inventors: David Thomas Gering, Waunakee, WI (US); Weiguo Lu, Madison, WI (US); Kenneth J. Ruchala, Madison, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 12/802,947

(22) Filed: Jun. 17, 2010

Related U.S. Application Data
(60) Provisional application No. 61/268,876, filed on Jun. 17, 2009.

(51) Int. Cl. G06K 9/00

(52) U.S. Cl. 382/131

(57) ABSTRACT

System and method of generating a warp field to generate a deformed image. The system and method use segmentation in a new method of image deformation with the intent of improving the anatomical significance of the results. Instead of allowing each image voxel to move in any direction, only a few anatomical motions are permissible. The planning image and the daily image are both segmented automatically. These segmentations are then analyzed to define the values of the few anatomical parameters that govern the allowable motions. Given these model parameters, a deformation or warp field is generated directly without iteration. The warp field is applied to the planning image or the daily image to deform the image. The deformed image can be displayed to a user.

### RELATED APPLICATIONS

This application is a non-provisional application of and claims priority to U.S. Provisional Patent Application Ser. No. 61/268,876, filed on Jun. 17, 2009, the contents of which are incorporated herein by reference.

### BACKGROUND OF THE INVENTION

Adaptive radiation therapy benefits from quantitative measures such as composite dose maps and dose volume histograms. The computation of these measures is enabled by a deformation process that warps the planning image (e.g., a KVCT image) to images acquired daily (e.g., a MVCT image) throughout the treatment regimen, which typically includes a treatment comprised of several fractions. Deformation methods have typically been based on optical flow, which implies that voxel brightness is considered without regard to the tissue type represented.

The type of transformation discovered by the deformation method has typically been free-form, which allows each image voxel to move in all directions. Therefore, a 3D image with 512×512 resolution and 40 slices would have 30 million degrees of freedom. Since the deformation problem is ill-posed (there are fewer equations than variables to solve), an additional constraint is imposed. This constraint has typically been spatial smoothness of the deformation field. The smoothness may be based on physical models, such as elastic solids or viscous fluids.

In order to be interactive, some have reduced the dimensionality of the problem by governing the deformation field with mathematical models that have few parameters. These mathematical constraints include B-splines and thin-plate splines controlled by image points manipulated by users. The dimensionality has also been reduced by measuring the modes of variation using Principle Component Analysis (“PCA”), and then controlling only a few parameters, one for each of the more major modes. PCA can be applied to points along contours, distance transforms from contours, and even the deformation field itself.

### SUMMARY OF THE INVENTION

An important factor in the delivery of image guided radiation therapy to a patient is the quality of the images used to plan, deliver, and adapt the radiation therapy, and particularly, the accuracy with which structures in the images are identified. For CT images, the data comprising the patient images are composed of image elements stored as data in the radiation therapy treatment system. These image elements may be any data construct used to represent image data, including two-dimensional pixels or three-dimensional voxels. In order to accurately analyze the patient images, the voxels are subjected to a process called segmentation. Segmentation first categorizes each element as being one of four different substances in the human body. These four substances or tissue types are air, fat, muscle and bone. The segmentation process may proceed to further subdivide bone tissue into individual bones, and important bones may be further subdivided into their anatomical parts. Other landmark structures, such as muscles and organs may be labeled individually.

One embodiment of the invention relates to the use of segmentation in a new method of image deformation with the intent of improving the anatomical significance of the results. Instead of allowing each image voxel to move in any direction, only a few anatomical motions are permissible. The planning image and the daily image are both segmented automatically. These segmentations are then analyzed to define the values of the few anatomical parameters that govern the allowable motions. Given these model parameters, a deformation or warp field is generated directly without iteration. This warp field is then passed into a pure free-form deformation process in order to account for any motion not captured by the model. Using a model to initially constrain the warp field can help to mitigate errors.

In some instances, segmenting an image (e.g., such as a particular structure in the image) can utilize an anatomical atlas. The atlas can be registered to the image in order to be used accurately. The segmenting may iterate between registering the atlas, and segmenting using the atlas. The output is a segmentation of the image, which identifies the voxels in the image according to its tissue type.

One challenge of prior methods of deforming an image being addressed is that optical-flow based registration systems, when implemented in basic form, permit unrealistic warps in perimeter structures. (In radiation therapy of the head and neck, these structures are the parotid glands and platysma muscles that line the nodal regions). One reason for this is that the areas of most visible change in the image immediately neighbor the areas of least visible change. The areas of most visible change are near the perimeter because the effects of weight loss accumulate radially outward from the patient center, thus moving perimeter structures the most. The areas of least visible change are the background just outside the patient because almost any background voxel appears to match perfectly with any other background voxel.

Another challenge of prior methods of deforming an image being addressed is that warp fields are constrained to be smooth (because otherwise the problem is ill-posed). However, the reality is that it should be smoothed out more in certain tissues than others, but there hasn't been a way to make the distinction. For example, weight loss should produce a more pronounced shrinkage in fat than muscle.

A further challenge of prior methods of deforming an image being addressed is that small inaccuracies in certain locations can have large impacts on cumulative dose, while large inaccuracies in certain locations can have no adverse effects. There hasn't been a way to focus attention on what counts.

In one aspect of the invention, the warped segmentation of the planning image (e.g., a KVCT image) is used to generate an atlas for assisting in segmenting the daily image (e.g., a MVCT image). The two segmentations are then used to generate a warp field, and this cycle can be iterated. The output is a deformation. Compare this work with atlas-based computer vision, where an atlas is registered with a scan in order to assist in segmenting it, and the output is a segmentation. One similarity of this work is that although the outputs are different, the intermediate results (a deformation and a segmentation) are similar. Another similarity is that various structures of interest can have different permissible transformations (one may be rigid, another an affine transform, and another a free-form vector field). In summary, the differences are the output (deformation vs. segmentation), the application (radiation therapy vs. computational neuroscience), the modality (CT vs. MR), and the certain anatomical effects that form the permissible motions.

In another aspect of the invention, no segmentation of the daily image (e.g., a MVCT image) is performed (anatomical parameters are found using optimization of a global image similarity metric), and the similarity with atlas-based segmentation is severed.

In another aspect of the invention, which may be considered a hybrid method, each anatomical structure is registered individually with corresponding motion constraints. The final deformation field is generated as weighted combinations of the deformation fields of individual structures. Multi-resolution or iterative schemes can be used to refine the results.

Another aspect of the invention is to provide an algorithm that warps the planning image (e.g., a KVCT image) to the daily image (e.g., MVCT image) in an anatomically relevant and accurate manner for adaptive radiation therapy, enabling the computation of composite dose maps and Dose Volume Histograms. This invention provides a means to insert anatomical constraints into the deformation problem with the intent of simplifying the calculations, constraining the results based on a priori information, and/or improving the anatomical significance of the result.

As noted above, instead of allowing each image voxel to move in any direction, only a few anatomical motions are permissible. Consider, for example, a head/neck application, then the anatomical effects are: a) spine can bend; b) mandible can swing; c) fat can shrink; and d) skin can warp.

The anatomically-constrained deformation can be a precursor to performing a modest free-form deformation in order to handle any motions not modeled by the algorithm. In this scheme, the invention is used to generate an initial warp field (motion vector at every voxel location) that is passed into the pure free-form deformation process, thereby reducing its errors.

In one particular embodiment, the invention provides a system for presenting data relating to a radiation therapy treatment plan for a patient. The system comprises a computer having a computer operable medium including instructions that cause the computer to: acquire a first image of a patient and a second image of the patient, the first image and the second image including a plurality of voxels; define a plurality of parameters related to anatomically allowable motion of the voxels; segment the first image to obtain a first segmentation identifying each voxel in the first image according to its tissue type; generate a warp field based on the values of the plurality of parameters; apply the warp field to deform data and to display the deformed data; and adjust the warp field by interactively instructing the computer to adjust at least one of the values of the plurality of the parameters.

In another particular embodiment, the invention provides a method of generating a warp field to deform an image. The method includes using a computer to: acquire a first image of a patient and a second image of the patient, the first image and the second image including a plurality of voxels; define a plurality of parameters related to anatomically allowable motion of the voxels; segment the first image to obtain a first segmentation identifying at least one voxel in the first image according to its tissue type; segment the second image to obtain a second segmentation identifying at least one voxel in the second image according to its tissue type; analyze the first segmentation and the second segmentation to determine values of the plurality of parameters; generate a warp field based on the values of the plurality of parameters; and apply the warp field to deform data.

In a further particular embodiment, the invention provides a method of generating a warp field to deform an image. The method comprises acquiring a first image of a patient and a second image of the patient, the first image and the second image including a plurality of voxels; defining a plurality of parameters related to anatomically allowable motion of the voxels; segmenting the first image to obtain a first segmentation identifying at least one voxel in the first image according to its tissue type; determining the plurality of parameter values to maximize a similarity of the first and second images wherein the first image is deformed while the plurality of parameter values are being determined; generating a warp field based on the values of the plurality of parameters; and applying the warp field to deform data.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a perspective view of a radiation therapy treatment system.

FIG. 2 is a perspective view of a multi-leaf collimator that can be used in the radiation therapy treatment system illustrated in FIG. 1.

FIG. 3 is a schematic illustration of the radiation therapy treatment system of FIG. 1.

FIG. 4 is a schematic diagram of a software program used in the radiation therapy treatment system.

FIG. 5 is a schematic illustration of a model of anatomically-constrained deformation according to one embodiment of the invention.

FIG. 6 illustrates a segmentation of a high-quality planning image that is used to guide the segmentation of a daily image.

FIG. 7 is a schematic illustration of the hierarchical steps of a segmentation process embodying the invention.

FIG. 8 illustrates a KV-CT organ segmentation that is converted into a tissue segmentation (only air, fat, muscle, and bone), which is then converted into a fuzzy probability map for use by the adaptive Bayesian classifier that segments the MVCT image.

FIG. 9 illustrates skin segmentations that form a start toward estimating the effect of weight loss, which shrinks fat primarily.

FIG. 10 illustrates examples of the generation of a warp field based on shrinking/expanding fat, or twisting and shifting vertebrae.

FIG. 11 illustrates several examples of the generation of a warp field based on twisting and shifting of the mandible.

FIG. 12 illustrates the effect of altering anatomical parameters (that move the mandible and spine independently) on the joint intensity histogram (image on left-hand side) that is used to compute Mutual Information as a global image similarity metric. Varying each anatomical parameter produces a smooth change in MI with a single global minimum. This makes an “error surface” that is well suited for automatic optimization.

FIG. 13 illustrates a planning image's segmentation that is used to generate an atlas.

FIG. 14 illustrates the warp field computed for a single anatomic effect (skin movement, in this figure) that needs to be smoothly spread out over a broad area, especially into the background.

FIG. 15 illustrates the effect when an anatomic parameter is assigned a greater weighting proximal to the corresponding anatomic structure (the darker areas of these distance transforms).

FIG. 16 illustrates a segmentation of an MVCT that requires knowledge gained from segmenting a KVCT.

FIG. 17 illustrates that as a single parameter that controls the mandible is varied, the mandible appears to swing up and down. The 3D surfaces are constructed from the automatic segmentation of the trachea (green), sinus (yellow), lungs (blue and pink), parotid glands (blue and pink) spine (gray and white), C1 (red), C2 (blue), brain (gray), and eyes (photo-realistic).

FIG. 18 illustrates the head swiveling, from side to side.

FIG. 19 illustrates the head tilting, from side to side.

FIG. 20 illustrates the head nodding, back and forth.

FIG. 21 illustrates the difference between KV-CT skin (red contour) and MV-CT skin (yellow contour) is measured at 30 spline control points. Motion vectors (green) emanate outward from bone centroids (blue). Two different patients are depicted, where the case on the right experienced significantly more weight loss.

FIG. 22 illustrates sectors (colored uniquely) that are defined to be the regions of the image corresponding to each control point. Voxels within each sector deform to a similar degree.

FIG. 23 illustrates images that are generated by varying the single parameter governing weight loss. From left-to-right, weight is progressively “subtracted” from the KV-CT image along the top row, while being “added” to the MV-CT image below.

FIG. 24 illustrates on the left: a warp field after processing bone alone; and on the right: a warp field after skin and bone have both been processed.

FIG. 25 illustrates the MV-CT shown with the planning contours overlaid. The result of rigid registration is on the left, while the result of ADD (not free-form) is on the right. Observe the significant motion of the mandible, and the change in patient weight.

FIG. 26 illustrates a flowchart of a method of generating a warp field to deform an image according to one embodiment of the invention.

FIG. 27 illustrates a flowchart of a method of generating a warp field to deform an image according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Although directional references, such as upper, lower, downward, upward, rearward, bottom, front, rear, etc., may be made herein in describing the drawings, these references are made relative to the drawings (as normally viewed) for convenience. These directions are not intended to be taken literally or limit the present invention in any form. In addition, terms such as “first,” “second,” and “third” are used herein for purposes of description and are not intended to indicate or imply relative importance or significance.

In addition, it should be understood that embodiments of the invention include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

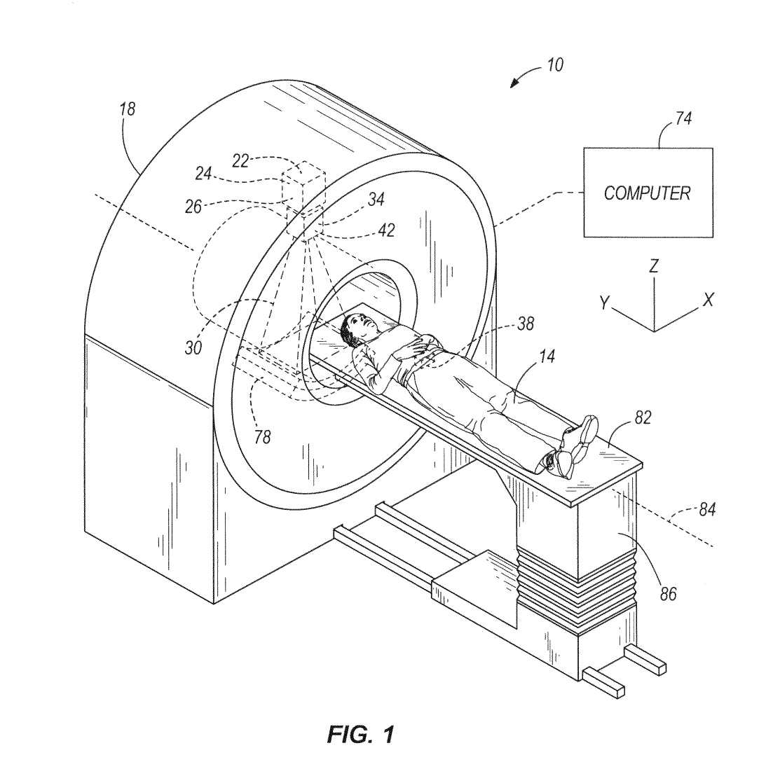

FIG. 1 illustrates a radiation therapy treatment system 10 that can provide radiation therapy to a patient 14. The radiation therapy treatment can include photon-based radiation therapy, brachytherapy, electron beam therapy, proton, neutron, or particle therapy, or other types of treatment therapy. The radiation therapy treatment system 10 includes a gantry 18. The gantry 18 can support a radiation module 22, which can include a radiation source 24 and a linear accelerator 26 (a.k.a. “a linac”) operable to generate a beam 30 of radiation. Though the gantry 18 shown in the drawings is a ring gantry, i.e., it extends through a full 360° arc to create a complete ring or circle, other types of mounting arrangements may also be employed. For example, a C-type, partial ring gantry, or robotic arm could be used. Any other framework capable of positioning the radiation module 22 at various rotational and/or axial positions relative to the patient 14 may also be employed. In addition, the radiation source 24 may travel in path that does not follow the shape of the gantry 18. For example, the radiation source 24 may travel in a non-circular path even though the illustrated gantry 18 is generally circular-shaped. The gantry 18 of the illustrated embodiment defines a gantry aperture 32 into which the patient 14 moves during treatment.

The radiation module 22 can also include a modulation device 34 operable to modify or modulate the radiation beam 30. The modulation device 34 provides the modulation of the radiation beam 30 and directs the radiation beam 30 toward the patient 14. Specifically, the radiation beam 30 is directed toward a portion 38 of the patient. Broadly speaking, a portion 38 may include the entire body, but is generally smaller than the entire body and can be defined by a two-dimensional area and/or a three-dimensional volume. A portion or area 38 desired to receive the radiation, which may be referred to as a target or target region, is an example of a region of interest. Another type of region of interest is a region at risk. If a portion 38 includes a region at risk, the radiation beam is preferably diverted from the region at risk. Such modulation is sometimes referred to as intensity modulated radiation therapy (“IMRT”).

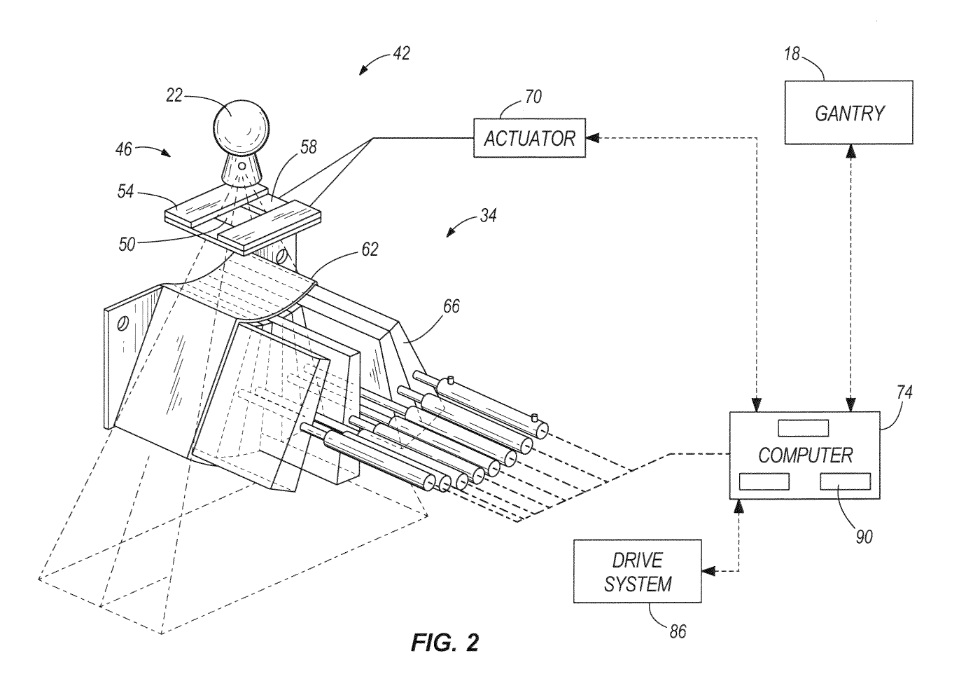

The modulation device 34 can include a collimation device 42 as illustrated in FIG. 2. The collimation device 42 includes a set of jaws 46 that define and adjust the size of an aperture 50 through which the radiation beam 30 may pass. The jaws 46 include an upper jaw 54 and a lower jaw 58. The upper jaw 54 and the lower jaw 58 are moveable to adjust the size of the aperture 50. The position of the jaws 46 regulates the shape of the beam 30 that is delivered to the patient 14.

In one embodiment, and illustrated in FIG. 2, the modulation device 34 can comprise a multi-leaf collimator 62 (a.k.a. “MLC”), which includes a plurality of interlaced leaves 66 operable to move from position to position, to provide intensity modulation. It is also noted that the leaves 66 can be moved to a position anywhere between a minimally and maximally-open position. The plurality of interlaced leaves 66 modulate the strength, size, and shape of the radiation beam 30 before the radiation beam 30 reaches the portion 38 on the patient 14. Each of the leaves 66 is independently controlled by an actuator 70, such as a motor or an air valve so that the leaf 66 can open and close quickly to permit or block the passage of radiation. The actuators 70 can be controlled by a computer 74 and/or controller.

The radiation therapy treatment system 10 can also include a detector 78, e.g., a kilovoltage or a megavoltage detector, operable to receive the radiation beam 30, as illustrated in FIG. 1. The linear accelerator 26 and the detector 78 can also operate as a computed tomography (CT) system to generate CT images of the patient 14. The linear accelerator 26 emits the radiation beam 30 toward the portion 38 in the patient 14. The portion 38 absorbs some of the radiation. The detector 78 detects or measures the amount of radiation absorbed by the portion 38. The detector 78 collects the absorption data from different angles as the linear accelerator 26 rotates around and emits radiation toward the patient 14. The collected absorption data is transmitted to the computer 74 to process the absorption data and to generate images of the patient's body tissues and organs. The images can also illustrate bone, soft tissues, and blood vessels. The system 10 can also include a patient support device, shown as a couch 82, operable to support at least a portion of the patient 14 during treatment. While the illustrated couch 82 is designed to support the entire body of the patient 14, in other embodiments of the invention the patient support need not support the entire body, but rather can be designed to support only a portion of the patient 14 during treatment. The couch 82 moves into and out of the field of radiation along an axis 84 (i.e., Y axis). The couch 82 is also capable of moving along the X and Z axes as illustrated in FIG. 1.

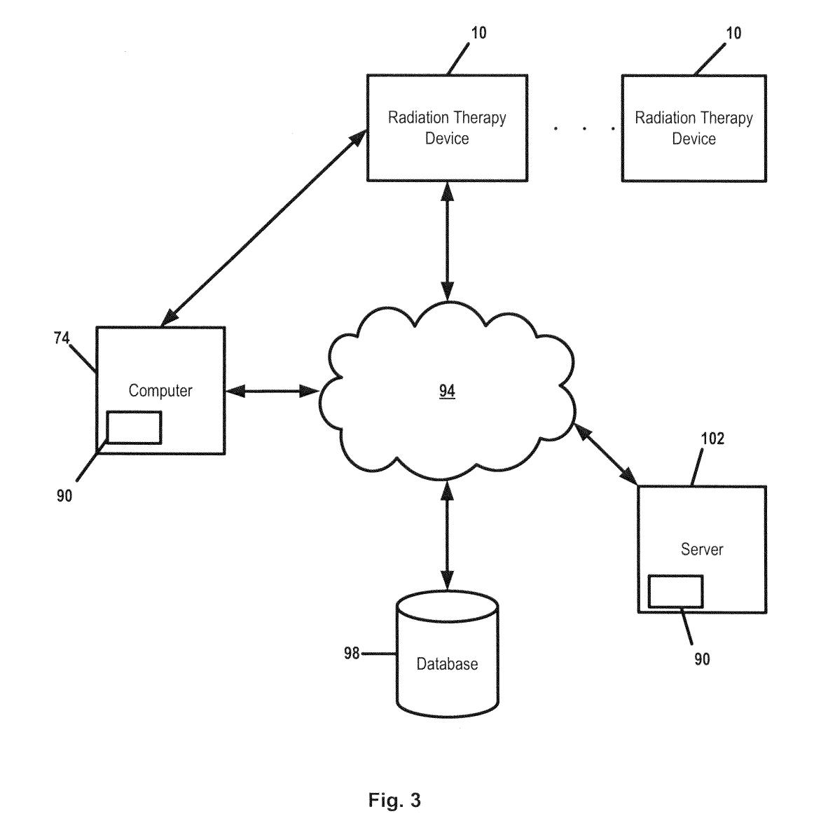

The computer 74, illustrated in FIGS. 2 and 3, includes an operating system for running various software programs (e.g., a computer readable medium capable of generating instructions) and/or a communications application. In particular, the computer 74 can include a software program(s) 90 that operates to communicate with the radiation therapy treatment system 10. The computer 74 can include any suitable input/output device adapted to be accessed by medical personnel. The computer 74 can include typical hardware such as a processor, I/O interfaces, and storage devices or memory. The computer 74 can also include input devices such as a keyboard and a mouse. The computer 74 can further include standard output devices, such as a monitor. In addition, the computer 74 can include peripherals, such as a printer and a scanner.

The computer 74 can be networked with other computers 74 and radiation therapy treatment systems 10. The other computers 74 may include additional and/or different computer programs and software and are not required to be identical to the computer 74, described herein. The computers 74 and radiation therapy treatment system 10 can communicate with a network 94. The computers 74 and radiation therapy treatment systems 10 can also communicate with a database(s) 98 and a server(s) 102. It is noted that the software program(s) 90 could also reside on the server(s) 102.

The network 94 can be built according to any networking technology or topology or combinations of technologies and topologies and can include multiple sub-networks. Connections between the computers and systems shown in FIG. 3 can be made through local area networks (“LANs”), wide area networks (“WANs”), public switched telephone networks (“PSTNs”), wireless networks, Intranets, the Internet, or any other suitable networks. In a hospital or medical care facility, communication between the computers and systems shown in FIG. 3 can be made through the Health Level Seven (“HL7”) protocol or other protocols with any version and/or other required protocol. HL7 is a standard protocol which specifies the implementation of interfaces between two computer applications (sender and receiver) from different vendors for electronic data exchange in health care environments. HL7 can allow health care institutions to exchange key sets of data from different application systems. Specifically, HL7 can define the data to be exchanged, the timing of the interchange, and the communication of errors to the application. The formats are generally generic in nature and can be configured to meet the needs of the applications involved.

Communication between the computers and systems shown in FIG. 3 can also occur through the Digital Imaging and Communications in Medicine (DICOM) protocol with any version and/or other required protocol. DICOM is an international communications standard developed by NEMA that defines the format used to transfer medical image-related data between different pieces of medical equipment. DICOM RT refers to the standards that are specific to radiation therapy data.

The two-way arrows in FIG. 3 generally represent two-way communication and information transfer between the network 94 and any one of the computers 74 and the systems 10 shown in FIG. 3. However, for some medical and computerized equipment, only one-way communication and information transfer may be necessary.

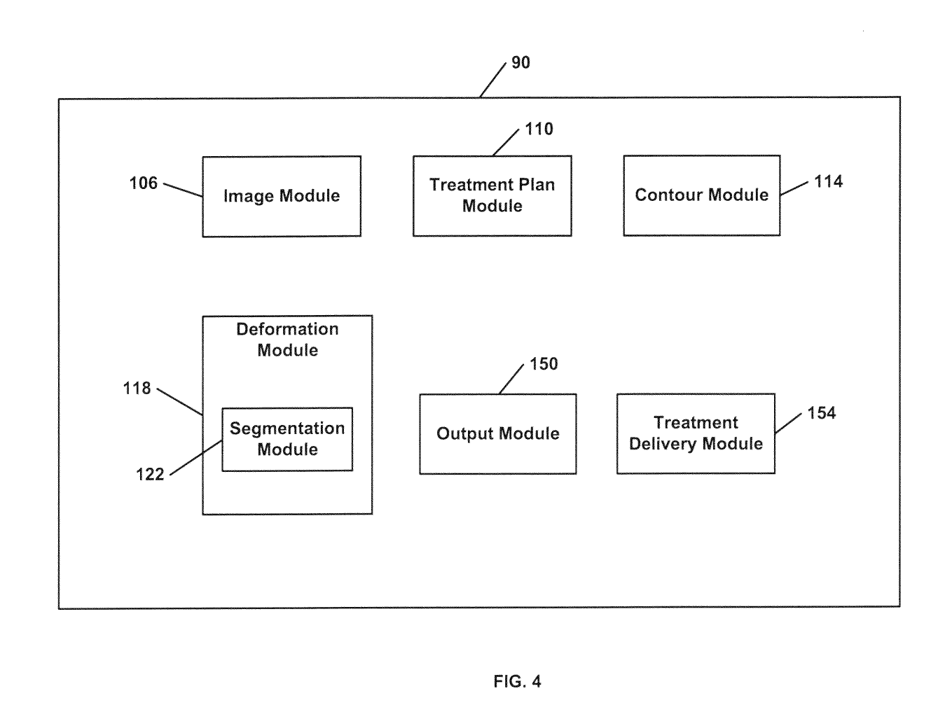

The software program 90 (illustrated in block diagram form in FIG. 4) includes a plurality of modules or applications that communicate with one another to perform one or more functions of the radiation therapy treatment process. The software program 90 can transmit instructions to or otherwise communicate with various components of the radiation therapy treatment system 10 and to components and/or systems external to the radiation therapy treatment system 10. The software program 90 also generates a user interface that is presented to the user on a display, screen, or other suitable computer peripheral or other handheld device in communication with the network 94. The user interface allows the user to input data into various defined fields to add data, remove data, and/or to change the data. The user interface also allows the user to interact with the software program 90 to select data in any one or more than one of the fields, copy the data, import the data, export the data, generate reports, select certain applications to run, rerun any one or more of the accessible applications, and perform other suitable functions.

The software program 90 includes an image module 106 operable to acquire or receive images of at least a portion of the patient 14. The image module 106 can instruct the on-board image device, such as a CT imaging device to acquire images of the patient 14 before treatment commences, during treatment, and after treatment according to desired protocols. For CT images, the data comprising the patient images are composed of image elements, which represent image elements stored as data in the radiation therapy treatment system. These image elements may be any data construct used to represent image data, including two-dimensional pixels or three-dimensional voxels.

In one aspect, the image module 106 acquires an image of the patient 14 while the patient 14 is substantially in a treatment position. Other off-line imaging devices or systems may be used to acquire pre-treatment images of the patient 14, such as non-quantitative CT, MRI, PET, SPECT, ultrasound, transmission imaging, fluoroscopy, RF-based localization, and the like. The acquired images can be used for registration/alignment of the patient 14 with respect to the gantry or other point and/or to determine or predict a radiation dose to be delivered to the patient 14. The acquired images also can be used to generate a deformation map to identify the differences between one or more of the planning images and one or more of the pre-treatment (e.g., a daily image), during-treatment, or after-treatment images. The acquired images also can be used to determine a radiation dose that the patient 14 received during the prior treatments. The image module 106 also is operable to acquire images of at least a portion of the patient 14 while the patient is receiving treatment to determine a radiation dose that the patient 14 is receiving in real-time.

The software program 90 includes a treatment plan module 110 operable to generate a treatment plan, which defines a treatment regimen for the patient 14 based on data input to the system 10 by medical personnel. The data can include one or more images (e.g., planning images and/or pre-treatment images) of at least a portion of the patient 14. These images may be received from the image module 106 or other imaging acquisition device. The data can also include one or more contours received from or generated by a contour module 114. During the treatment planning process, medical personnel utilize one or more of the images to generate one or more contours on the one or more images to identify one or more treatment regions or avoidance regions of the portion 38. The contour process can include using geometric shapes, including three-dimensional shapes to define the boundaries of the treatment region of the portion 38 that will receive radiation and/or the avoidance region of the portion 38 that will receive minimal or no radiation. The medical personnel can use a plurality of predefined geometric shapes to define the treatment region(s) and/or the avoidance region(s). The plurality of shapes can be used in a piecewise fashion to define irregular boundaries. The treatment plan module 110 can separate the treatment into a plurality of fractions and can determine the amount of radiation dose for each fraction or treatment (including the amount of radiation dose for the treatment region(s) and the avoidance region(s)) based at least on the prescription input by medical personnel.

The software program 90 can also include a contour module 114 operable to generate one or more contours on a two-dimensional or three-dimensional image. Medical personnel can manually define a contour around a target 38 on one of the patient images. The contour module 114 receives input from a user that defines a margin limit to maintain from other contours or objects. The contour module 114 can include a library of shapes (e.g., rectangle, ellipse, circle, semi-circle, half-moon, square, etc.) from which a user can select to use as a particular contour. The user also can select from a free-hand option. The contour module 114 allows a user to drag a mouse (a first mouse dragging movement or swoop) or other suitable computer peripheral (e.g., stylus, touchscreen, etc.) to create the shape on a transverse view of an image set. An image set can include a plurality of images representing various views such as a transverse view, a coronal view, and a sagittal view. The contour module 114 can automatically adjust the contour shape to maintain the user-specified margins, in three dimensions, and can then display the resulting shape. The center point of the shape can be used as an anchor point. The contour module 114 also allows the user to drag the mouse a second time (a second consecutive mouse dragging movement or swoop) onto a coronal or sagittal view of the image set to create an “anchor path.” The same basic contour shape is copied or translated onto the corresponding transverse views, and can be automatically adjusted to accommodate the user-specified margins on each view independently. The shape is moved on each view so that the new shape's anchor point is centered on a point corresponding to the anchor path in the coronal and sagittal views. The contour module 114 allows the user to make adjustments to the shapes on each slice. The user may also make adjustments to the limits they specified and the contour module 114 updates the shapes accordingly. Additionally, the user can adjust the anchor path to move individual slice contours accordingly. The contour module 114 provides an option for the user to accept the contour set, and if accepted, the shapes are converted into normal contours for editing.

During the course of treatment, the patient typically receives a plurality of fractions of radiation (i.e., the treatment plan specifies the number of fractions to irradiate the tumor). For each fraction, the patient is registered or aligned with respect to the radiation delivery device. After the patient is registered, a daily pre-treatment image (e.g., a 3D or volumetric image) is acquired while the patient remains in substantially a treatment position. The pre-treatment image can be compared to previously acquired images of the patient to identify any changes in the target 38 or other structures over the course of treatment. The changes in the target 38 or other structures is referred to as deformation. Deformation may require that the original treatment plan be modified to account for the deformation. Instead of having to recontour the target 38 or the other structures, the contour module 114 can automatically apply and conform the preexisting contours to take into account the deformation. To do this, a deformation algorithm (discussed below) identifies the changes to the target 38 or other structures. These identified changes are input to the contour module 114, which then modifies the contours based on those changes.

A contour can provide a boundary for auto-segmenting the structure defined by the contour. Segmentation (discussed below in more detail) is the process of assigning a label to each voxel or at least some of the voxels in one of the images. The label represents the type of tissue present within the voxel. The segmentation is stored as an image (array of voxels). The finalization of the contour can trigger an algorithm to automatically segment the tissue present within the boundaries of the contour.

The software program 90 can also include a deformation module 118 operable to deform an image(s) while improving the anatomical significance of the results. The deformation of the image(s) can be used to generate a deformation map to identify the differences between one or more of the planning images and one or more of the daily images.

The deformed image(s) also can be used for registration of the patient 14 and/or to determine or predict a radiation dose to be delivered to the patient 14. The deformed image(s) also can be used to determine a radiation dose that the patient 14 received during the prior treatments or fractions. The image module 106 also is operable to acquire one or images of at least a portion of the patient 14 while the patient is receiving radiation treatment that can be deformed to determine a radiation dose that the patient 14 is receiving in real-time.

Adaptive radiation therapy, when considering the anatomical significance of the results, benefits from quantitative measures such as composite dose maps and dose volume histograms. The computation of these measures is enabled by a deformation process that warps the planning image (e.g., a KVCT image) to one or more daily images (e.g., MVCT image) acquired throughout the treatment regimen in an anatomically relevant and accurate manner for adaptive radiation therapy.

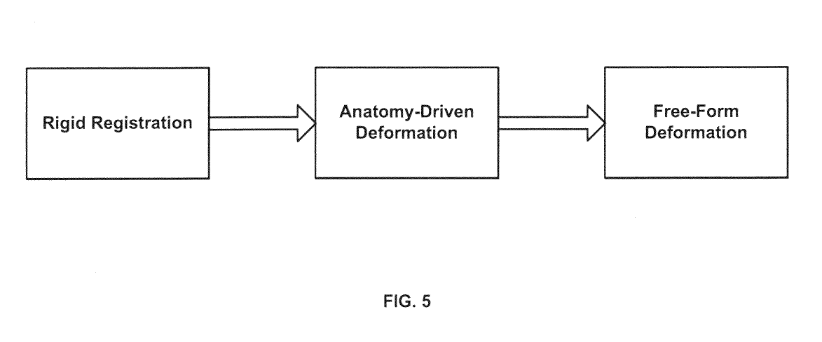

As noted above, a deformation algorithm, which is anatomy-driven according to one embodiment of the invention, is applied to one or more images to identify the changes to the target 38 or other structures of the patient. As illustrated in FIG. 5, the anatomy-driven deformation algorithm allows each image voxel in the image(s) to move only in a few anatomically permissible motions rather than in any direction. The anatomically permissible motions can be expressed with a handful of parameters, and after segmentation of the image(s), particular values of the parameters are determined. These parameter values are used to generate a warp field, which can be useful for initializing free-form deformation.

The anatomically constrained deformation can be a precursor to performing a modest free-form deformation in order to handle any motions not modeled by the algorithm. In this scheme, the invention is used to generate an initial warp field (motion vector at every voxel location) that can be passed into the pure free-form deformation process, thereby reducing its errors.

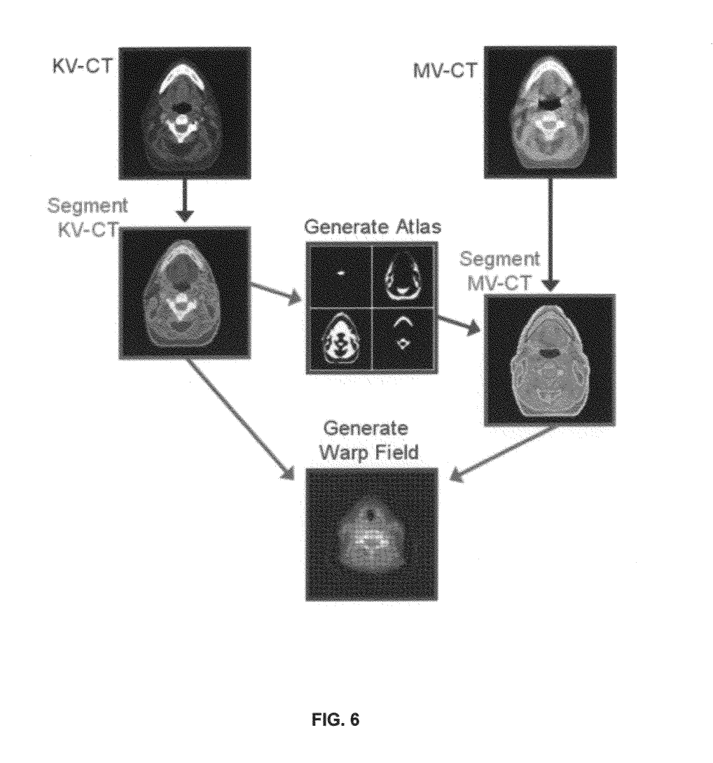

The generated warp field (see FIG. 6) can be applied to data, such as dosimetric data, one or more of the patient images, one or more of the contours on one of the patient images, or any other image (e.g., MRI image and a PET image). The output of the application of the warp field to the data is a deformed image, which can be displayed to the medical personnel. The medical personnel can use this deformed data to evaluate whether changes should be made to the patient's treatment plan for current or future treatment fractions.

The deformation module 118 can include a segmentation module 122 for effecting segmentation of the images acquired by the image module 106. For CT images, the data comprising the patient images are composed of image elements, which represent image elements stored as data in the radiation therapy treatment system. These image elements may be any data construct used to represent image data, including two-dimensional pixels or three-dimensional voxels. In order to accurately analyze the patient images, the voxels are subjected to a process called segmentation. Segmentation categorizes each element as being one of four different substances in the human body. These four substances or tissue types are air, fat, muscle and bone. FIG. 6 illustrates the segmentation of a high-quality planning image (e.g., a KVCT image), which is used to guide the segmentation of the daily image (e.g., a MVCT image).

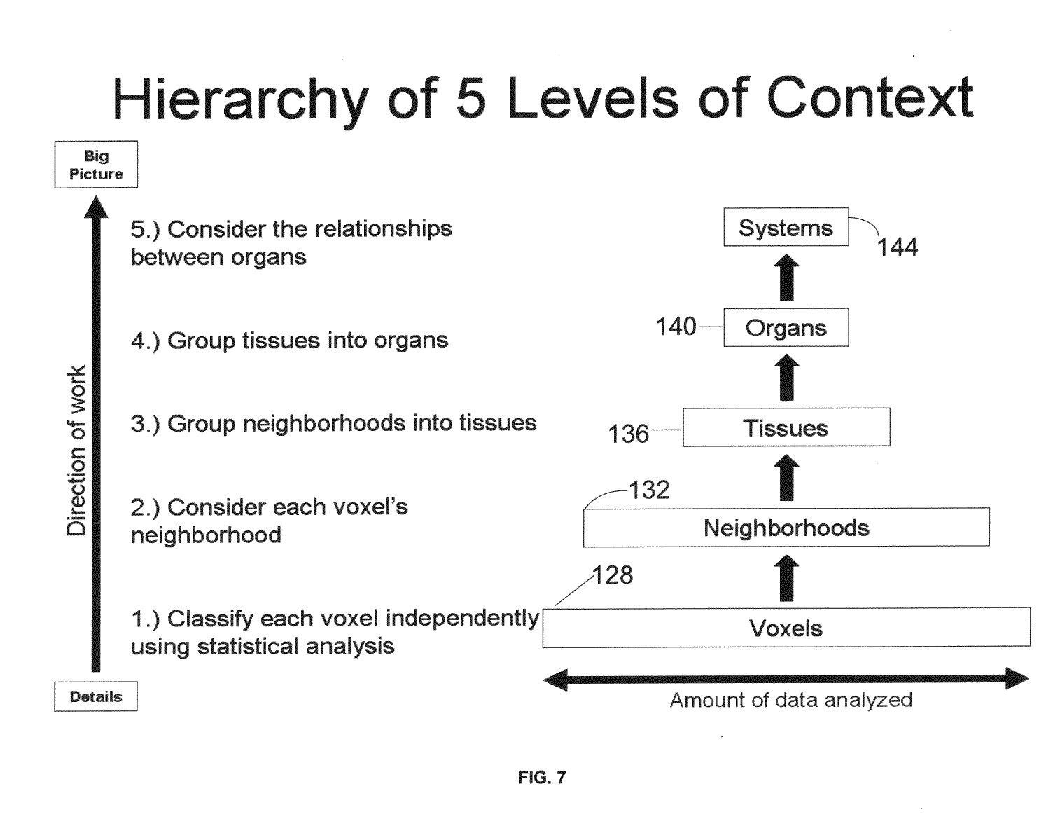

The segmentation module 122 can apply a 5-layer hierarchy (FIG. 7) of segmentation steps that first analyzes each image element individually (the image element or voxel layer 128), then analyzes neighborhoods or groups of image elements collectively (the neighborhood layer 132), organizes them into tissue groups (the tissue layer 136), then organs (the organ layer 140) and finally organ systems (the systems layer 144). The 5-layer hierarchy of steps combines rule-based, atlas-based and mesh-based approaches to segmentation in order to achieve both recognition and delineation of anatomical structures, thereby defining the complete image as well as the details within the image. Such a framework (where local decisions are supported by global properties) is useful in addressing inconsistent segmentation or image results, such as, for example, may be encountered when there exists inconsistent rectum contents from image to image, or from image slice to image slice. Additional information regarding segmentation can be found in co-pending U.S. patent application Ser. No. 12/380,829, the contents of which are incorporated herein by reference.

The segmentation module 122 may be a stand-alone software module or may be integrated with the deformation module 118. Moreover, the segmentation module 122 may be stored on and implemented by computer 74, or can be stored in database(s) 98 and accessed through network 94. In the embodiment shown in FIG. 4, the segmentation module 122 is identified as part of the deformation module 118.

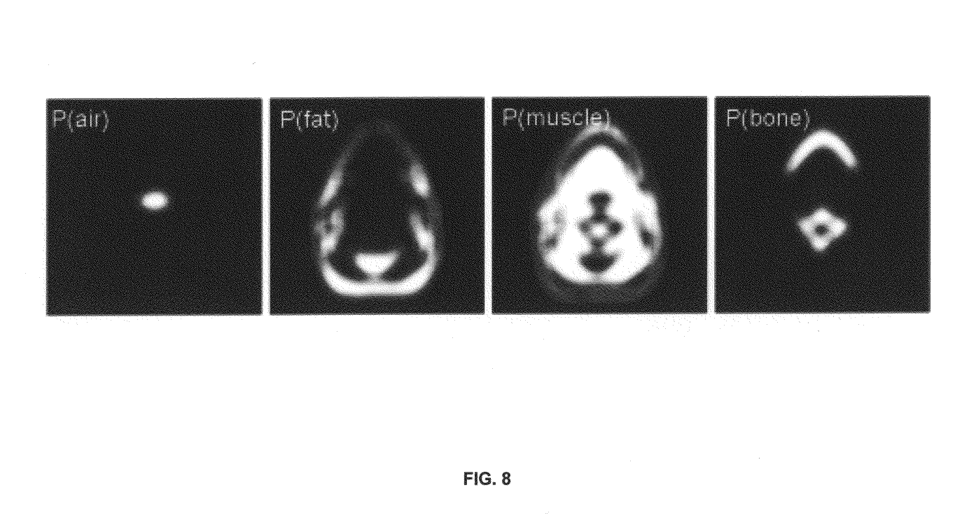

In some instances, segmenting an image (e.g., such as a particular structure in the image) can utilize an anatomical atlas. The atlas can be registered to the image in order to be used accurately. The segmenting can optionally iterate between registering the atlas, and segmenting using the atlas. The output is a segmentation of the image, which identifies the voxels in the image according to its tissue type. Daily images often feature a different contrast method, resolution, and signal-to-noise ratio than the high quality planning image. Therefore, the segmentation of the planning image is leveraged to generate a probabilistic atlas (spatially varying map of tissue probabilities) to assist in the segmentation of the daily image, as shown in FIG. 8. FIG. 8 illustrates that a KV-CT organ segmentation is converted into a tissue segmentation (only air, fat, muscle, and bone), which is then converted into a fuzzy probability map for use by the adaptive Bayesian classifier that segments the MVCT image. In this FIG. 8, the brighter the voxel's intensity value, the more likely the tissue can be found there.

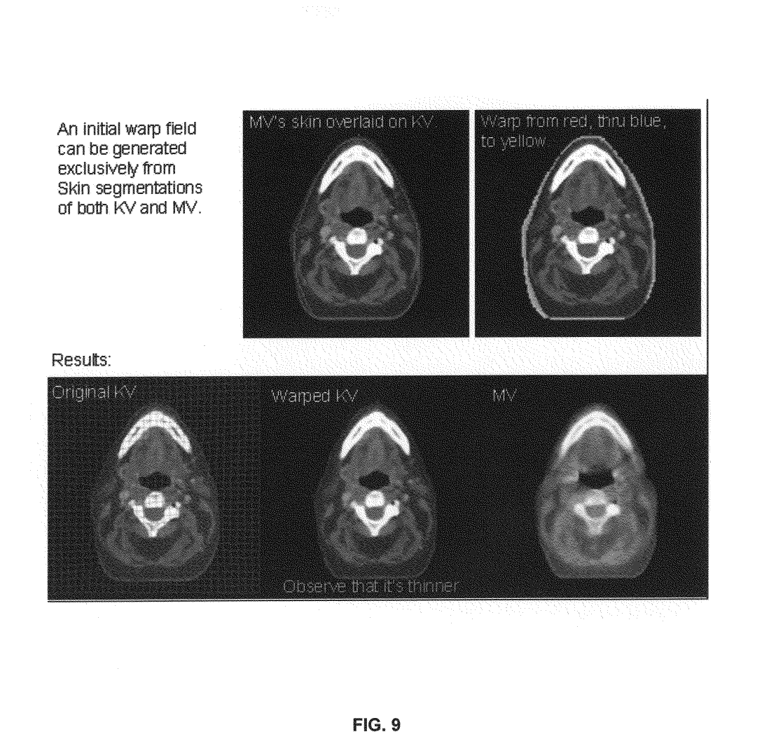

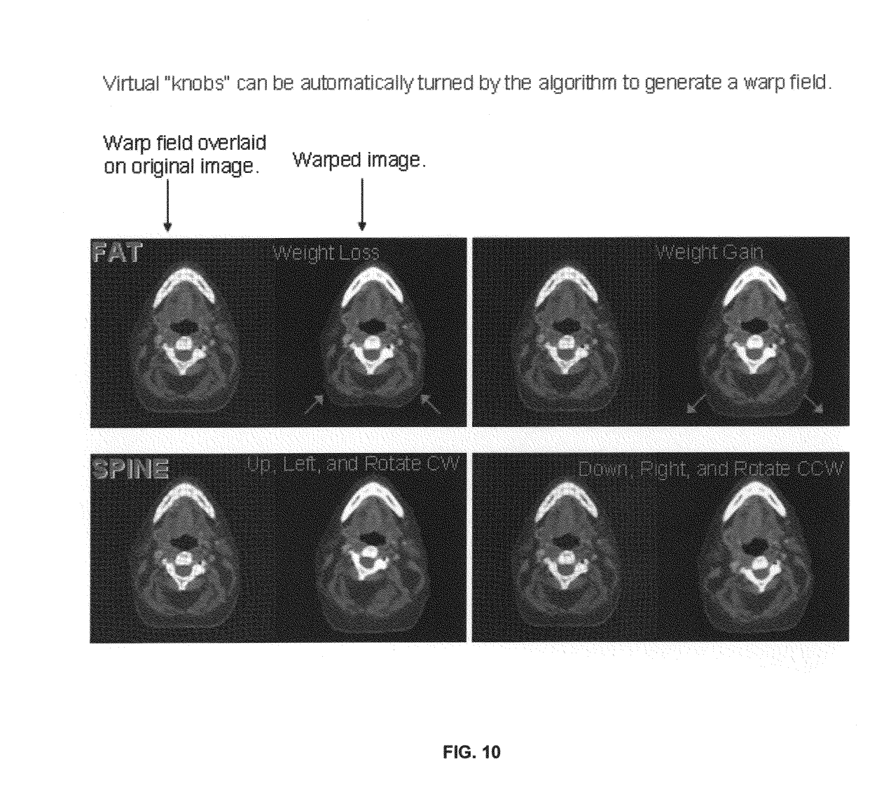

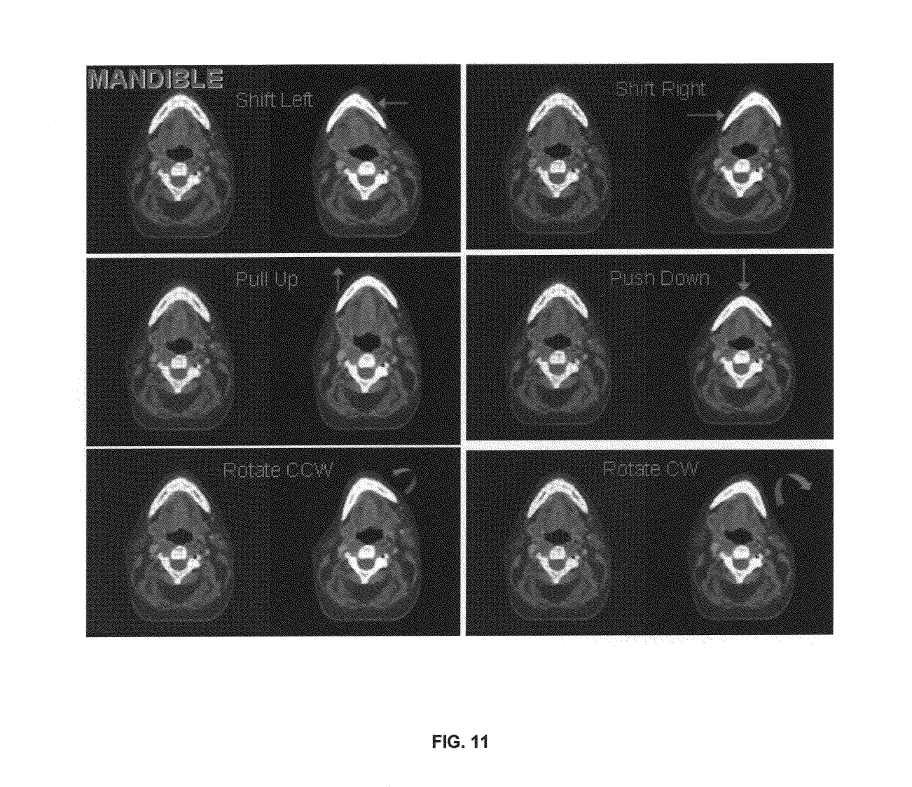

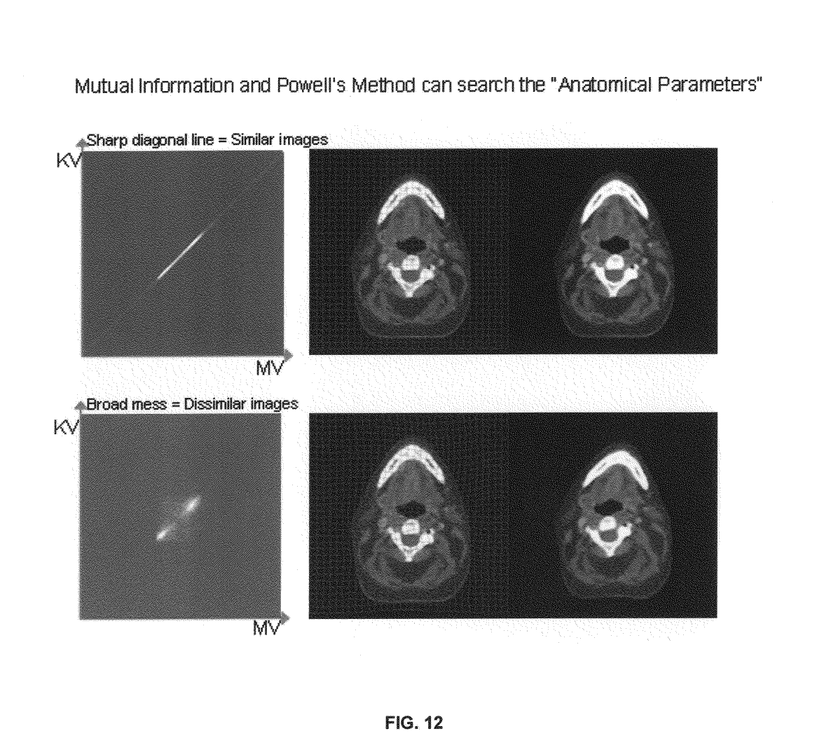

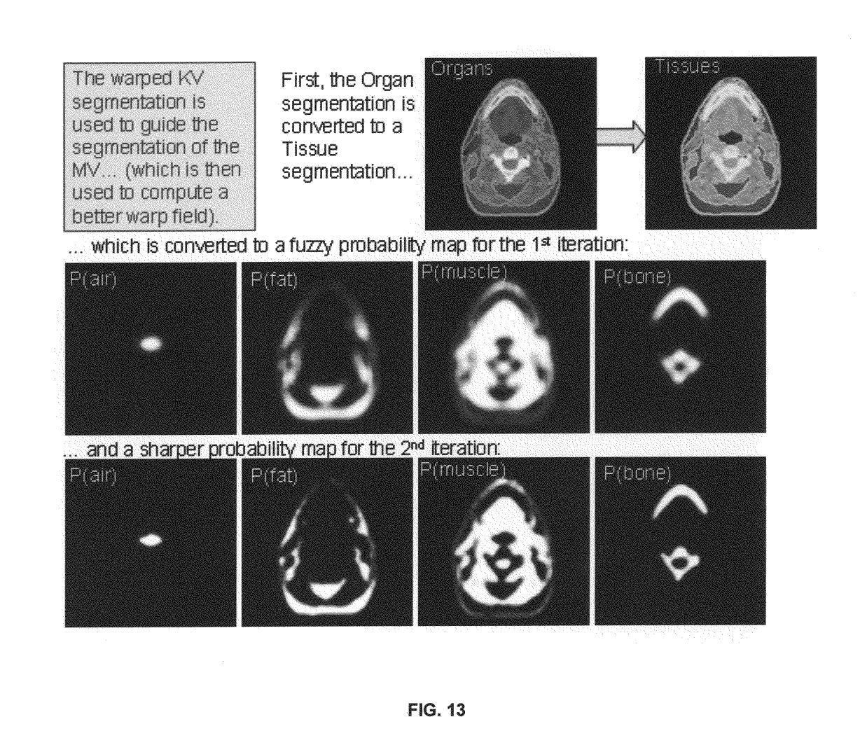

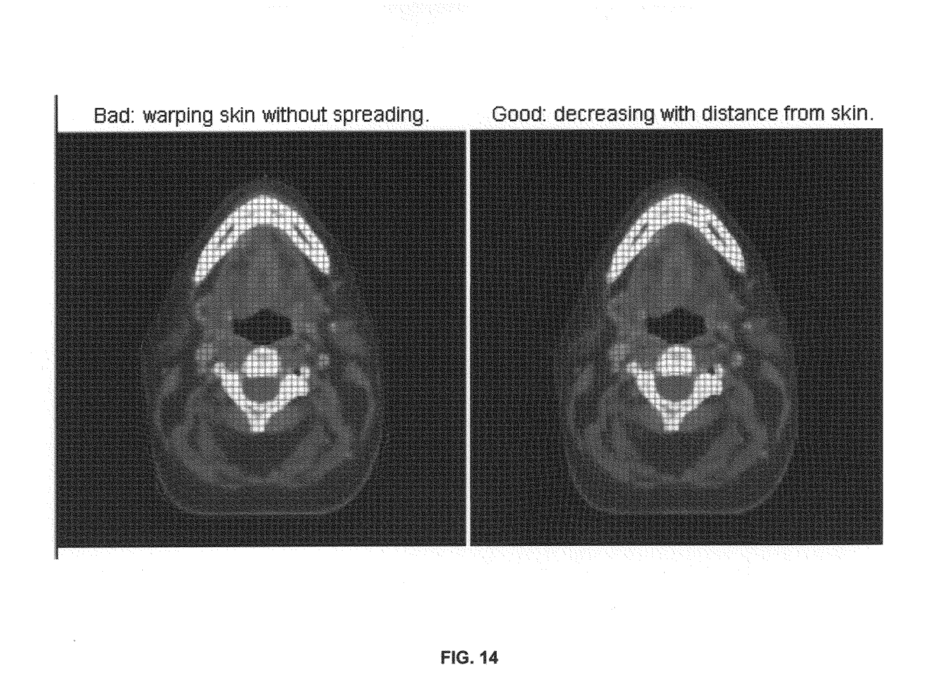

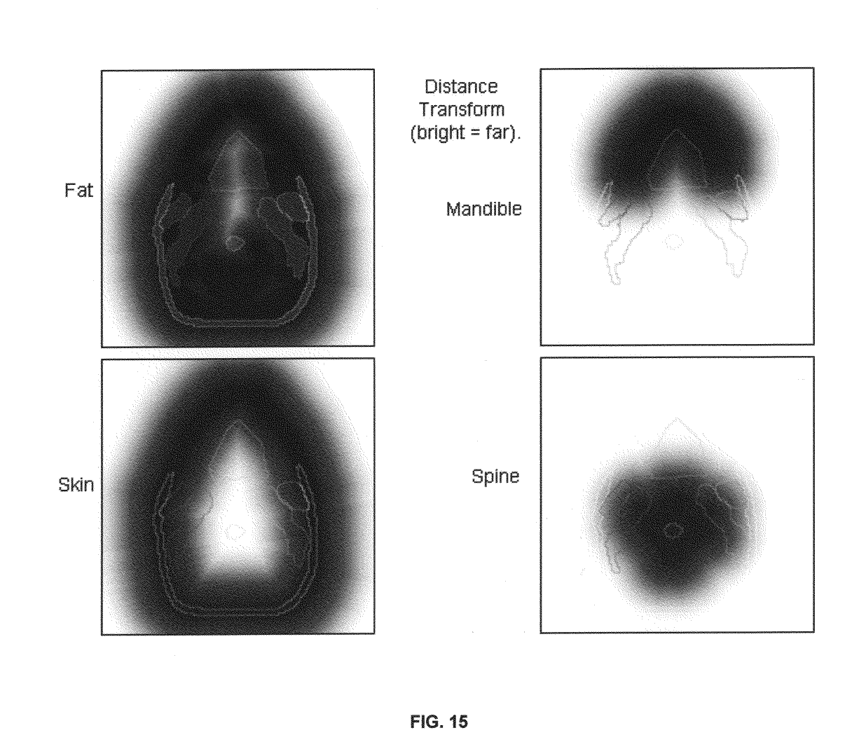

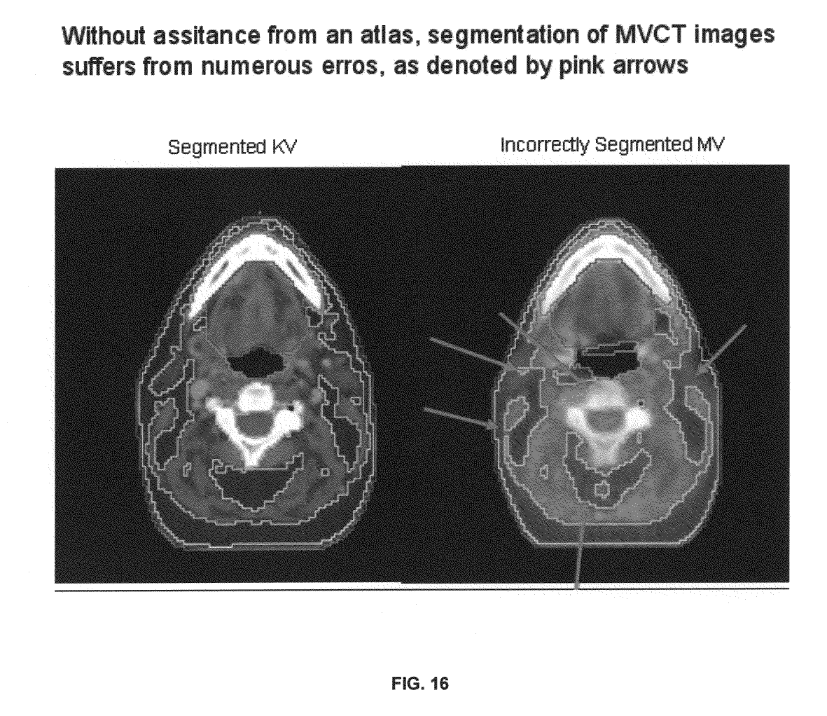

In one embodiment, the deformation algorithm uses available optimization methods (e.g., Powell's method, conjugate gradient, Levenburg-Marquardt, simplex method, 1+1 evolution, brute force) to search the parameter space (of anatomically permissible effects). At each step of the optimization, a set of anatomic parameters is considered by generating a warp field (as illustrated in FIGS. 9-16), using the warp field to deform the KVCT, and then evaluating a similarity measure between the deformed KVCT and the daily MVCT. The similarity measure can be Mutual Information, normalized mutual information, or a sum of squared differences combined with histogram equalization. Based on the value of the similarity measure, the optimization proceeds to try a different set of parameter values, and this iterates until convergence.

In another embodiment, the KVCT and MVCT are segmented, and the differences between their segmentations are used to generate a warp field. The warp field is then applied to the KVCT to warp its segmentation. The warped segmentation is then used to generate a probabilistic atlas. The atlas is used to assist in the segmentation of the MVCT (assistance is required because the MVCT has more noise and less contrast than the KVCT). The segmented MVCT can then be used to regenerate the warp field, and the iteration continues.

As the iterations progress, we can afford to generate the atlas with increasing sharpness because we can assume that the gap in spatial correspondences between the MVCT and the warped KVCT is closing.

Since each anatomic parameter can be used to generate a warp field, the effects of all parameters must be combined somehow into a single warp field. A preferred embodiment is to weight the effect at each voxel by the Euclidean distance to each anatomical structure. After blending in this way, the field is checked and smoothed sufficiently to guarantee that it is diffeomorphic (both invertible and differentiable).

The deformation algorithm can be implemented in a Bayesian framework where the iterations accomplish Expectation Maximization. The E-step solves the Maximum A Posteriori probabilities (for MVCT segmentation) given the current model parameters (prior probabilities generated from the KVCT segmentation, and deformation field generated by the anatomical effects). The M-step relies on the current MAP probabilities to update the estimation of the parameters.

In another embodiment, which may be considered a hybrid of the first two embodiments, each anatomical structure is registered individually with corresponding motion constraints. Segmentation may be used for some structures (such as skin), but not for others that may be more difficult to segment (such as platysma). The final deformation field is generated as a weighted combination of the deformation fields of individual structures. Multi-resolution or iterative schemes can be used to refine the results.

In one example, consider the head/neck application of radiation therapy. The skin can be segmented and used for an initial estimate of the anatomical effect of weight loss. This in turn is used to generate an initial warp field, which is then used to deform the probabilistic atlas derived from the KVCT. The subsequent segmentation of the MVCT can identify other structures of the anatomical model, such as mandible and spine. These can then be rigidly registered with the corresponding structures in the KVCT. Alternatively, the parameters that govern their registrations can be found in a search which generates trial warp fields for each possible parameter value. The former method relies more on the local segmentation, while the latter method relies more on the global effect of the warp field derived from the anatomic motion.

Furthermore, segmentations of multiple structures can be used to drive the estimation of a set of parameters that govern a single permissible anatomic motion. For example, after each vertebrae has been segmented on each 2D slice, a 3D spline could be fit through their centers, which would be used to generate a single 3D warp field (corresponding with the rule that “spine can bend”). In this case, there is another set of parameters (spline coefficients) being found by the EM algorithm. Instead of spline coefficients, parameters could also be control points for statistical shape models or local deformations (such as restricting how the platysma muscle is allowed to bend).

Another aspect of the invention is that the applicable anatomical constraints could be further refined based upon various clinical scenarios. For example, a broadest tier of anatomical constraints might be a generalized description of typical organ motions, ranges of motions, and impact on the images.

The specification of possible spinal or mandibular motions might fit this category. However, an additional category may further refine permissible and expected motions based on cohort specific information. This may include a priori knowledge that the patient is being treated for a certain type of cancer, and that typical motions or anatomical changes differ in the vicinity of that type of lesion as opposed to other types. Further classification may be based on patient specific information, such as knowledge of prior treatment, resections, implants, or other distinguishing characteristics. When the invention is being applied in the context of adaptive radiation therapy, treatment information such as delivered dose might also be incorporated so the constrained deformation might reflect the impact such dose might have on localized shrinkage or swelling of tissues. In essence, just as deformation can be solved for substantially every voxel initially, or using a multi-resolution approach for increasing detail, these additional cohort and patient constraints can be applied initially, or as a type of multi-resolution introduction of anatomical constraints.

In addition, the invention can also incorporate additional images beyond a single diagnostic image and daily image. The benefit of this is to further refine anatomical constraints based using content and/or consistency information provided from the additional images. For example, some of the constraints identified above, such as weight loss, would be generally expected to be more gradual in time. Other constraints, such as mandible position might change substantially and unpredictably from image-to-image. As such, when solving for the warp field for an image in a temporal series, perhaps taken over a month as occurs in adaptive therapy, the weight loss can be further constrained to be roughly monotonic over the month.

In this regard, the information from prior images can be applied when solving for the warp field for a single new image; but an additional embodiment would be to currently solve for the warp fields for all of the images to ensure anatomically consistent changes in each.

Also, the use of multiple images could be used to leverage the characteristics of each imaging system. For example, a daily image taken on the treatment system might be the best indicator of the patient's position as well as spinal alignment on a given day, but an additional CT image, MRI image, PET image, or the like taken on a separate system might provide additional constraints on the likely size or shapes of relevant organs.

One other aspect of the invention is the opportunity to apply additional constraints and modifications to account for intrafraction motion. This may be applicable in cases where a pre-treatment image such as an MVCT is the primary image used for deformation, but additional information is collected during treatment, such as through a camera or implanted marker. This additional information could then be used, in conjunction with other constraints, to create warp maps that represents the relations not only between the planning image and the pre-treatment image, but between the planning image and the most likely patient anatomical representation during one or more times of the treatment delivery.

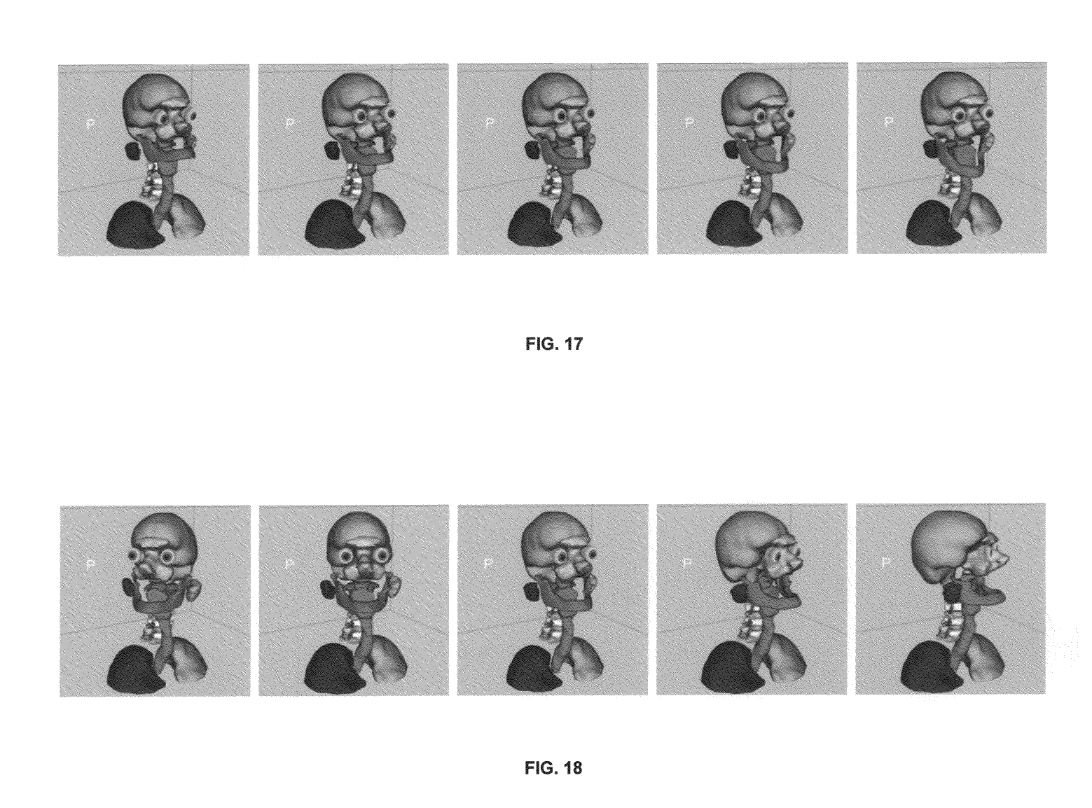

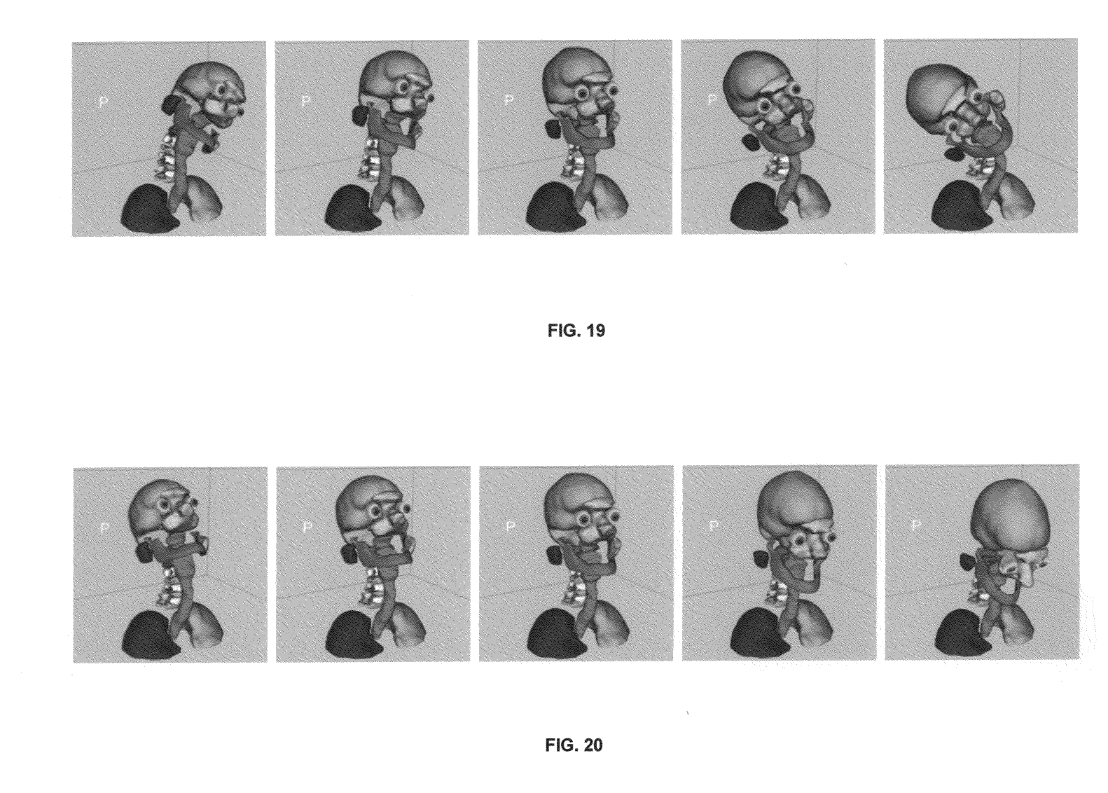

In one example, deformation attributed to bone motion using the deformation algorithm according to one embodiment of the invention is illustrated in FIGS. 17-20. The cranium, mandible, and spine are permitted to twist and shift as somewhat independent rigid bodies whose motions are governed by only four parameters. All four of these bone motions are depicted graphically in FIGS. 17-20. For example, the mandible expresses a swinging motion by rotating about the axis connecting its lateral condyles located superiorly and posteriorly. Entirely independent from the mandible, the cranium and spine coordinate to perform three motions, as illustrated in FIGS. 18-20. The dens bone acts as the center of rotation for head tilt side-to-side, head nodding back and-forth, and head swivel side-to-side. In the model, 80% of the rotation is attributed to C1, and the remainder is distributed across C2-C7 by interpolation.

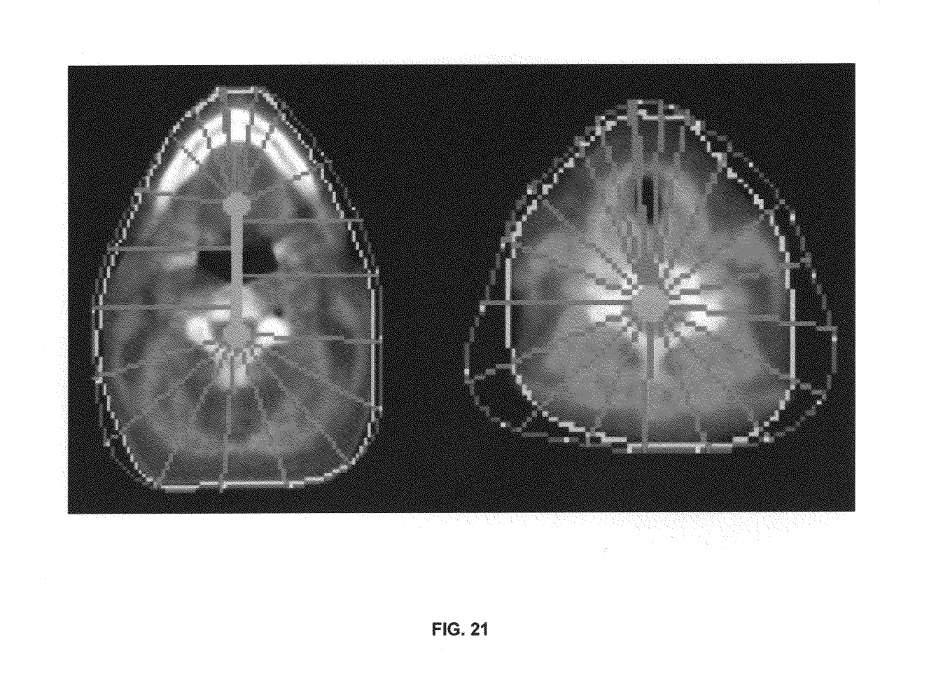

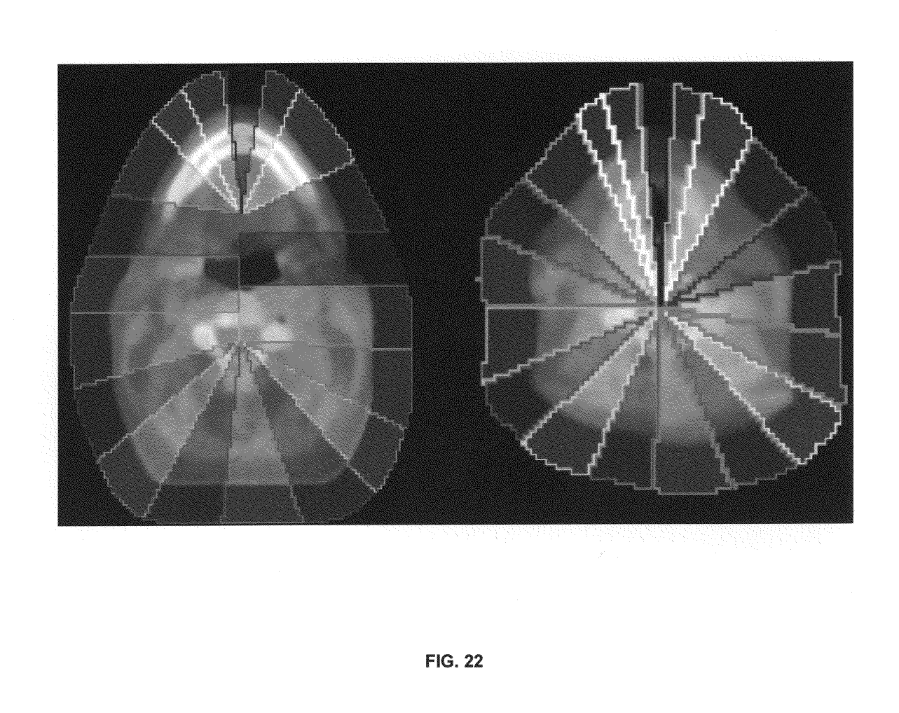

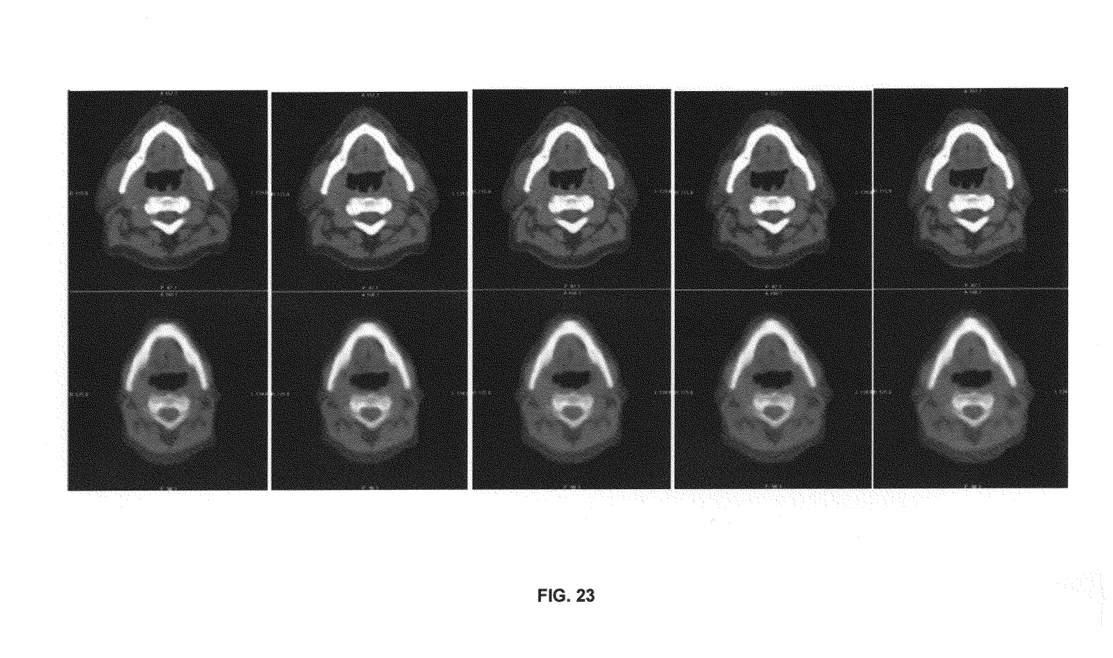

In another example, deformation attributed to weight loss using the deformation algorithm according to one embodiment of the invention is illustrated in FIGS. 21-23. All deviations between the two skin surfaces are attributed to weight loss. The difference is therefore reconciled by expanding the fatty tissue outward in a radial fashion in the axial plane. The origin of the radial expansion is the centroid of the spinal cord. On slices where the mandible is present, a central axis is drawn through the spine and mandible, as shown in FIG. 21. The motion vectors are defined to emanate outward from the central axis to each of 20 control points. The control points form a spline that is fit to the boundary of the skin segmentation. The magnitude of the expansion is measured from the gap between the two splines representing KV-CT and MV-CT skin. The measured difference is distributed along the entire path from the centroid in accordance with the type of tissue present along the path. In the computational model, fat tissue is favored to shrink 10:1 over muscle tissue. The sectors shown in FIG. 22 facilitate robust measurements and assist in maintaining the effects to be smoothly varying.

FIG. 23 illustrates the results of varying the single parameter that is responsible for representing weight loss visible at the skin. The images along the top row depict the KV-CT “losing weight,” while the images along the bottom row depict the MV-CT “gaining weight.” Similarly, an additional parameter can be introduced to control weight loss manifested at the pharynx.

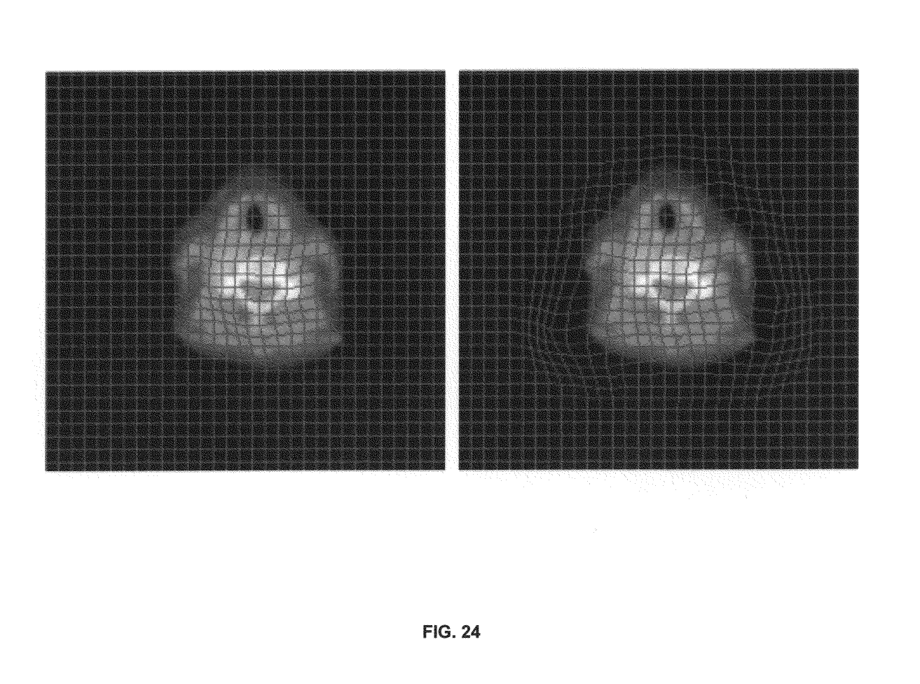

Weight-loss deformation is computed after bone deformation, and added to the warp field with only the minimal smoothness required to maintain an invertible field, as shown in FIG. 24. At each voxel, the impact of each actor is weighted by the distance to the actor's surface, as measured using euclidean distance transforms. The warp fields are intentionally carried outside the patient into the surrounding empty space, and then linearly ramped down gradually from there.

The software program 90 also can include an output module 150 operable to generate or display data to the user via the user interface. The output module 150 can receive data from any one of the described modules, format the data as necessary for display and provide the instructions to the user interface to display the data. For example, the output module 150 can format and provide instructions to the user interface to display the combined dose in the form of a numerical value, a map, a deformation, an image, a histogram, or other suitable graphical illustration.

The software program 90 also includes a treatment delivery module 154 operable to instruct the radiation therapy treatment system 10 to deliver the radiation fraction to the patient 14 according to the treatment plan. The treatment delivery module 154 can generate and transmit instructions to the gantry 18, the linear accelerator 26, the modulation device 34, and the drive system 86 to deliver radiation to the patient 14. The instructions coordinate the necessary movements of the gantry 18, the modulation device 34, and the drive system 86 to deliver the radiation beam 30 to the proper target in the proper amount as specified in the treatment plan.

In one particular example, the segmentation and deformation method disclosed herein has been trained and tested on ten clinical head/neck datasets where the daily images are TomoTherapy® megavoltage CT scans. The average processing time, for volumes with roughly 110 slices and 256×256 pixels per slice, is only 40 seconds on a standard PC, without any human interaction.

Several types of errors that were evident when using free-form deformation were observed to be addressed by anatomically driven deformation (ADD). These included problems with distorted bones, the spinal cord leaving its cavity, muscle tissue leaking into nodal regions, and parotid gland issues near the periphery.

To obtain quantitative results, we compared the similarity measure computed after rigid registration, after ADD, and after free-from deformation. The percentage of the improvement in similarity captured by ADD was measured to vary between 52% and 82%.

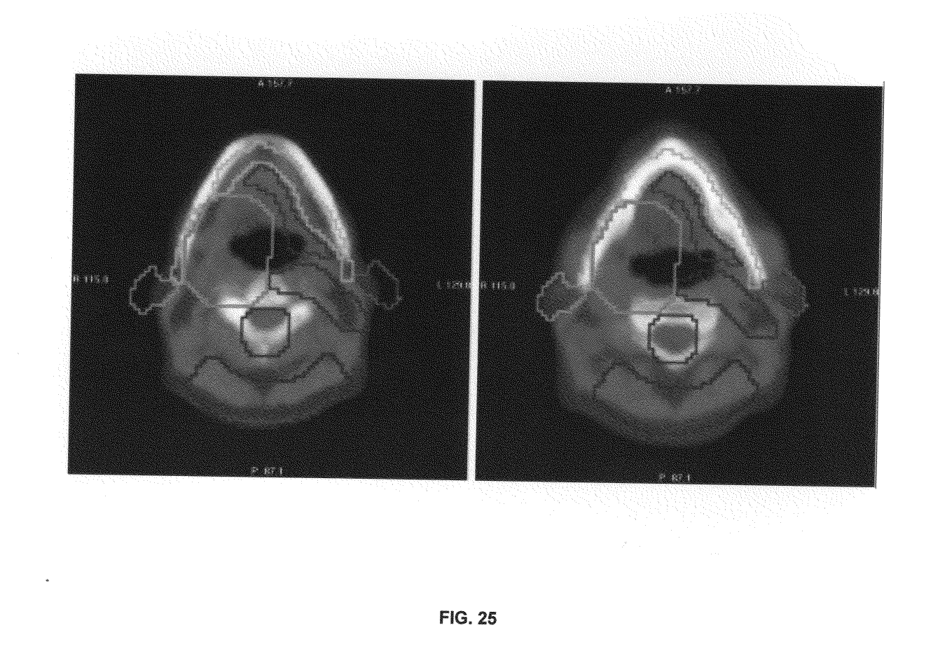

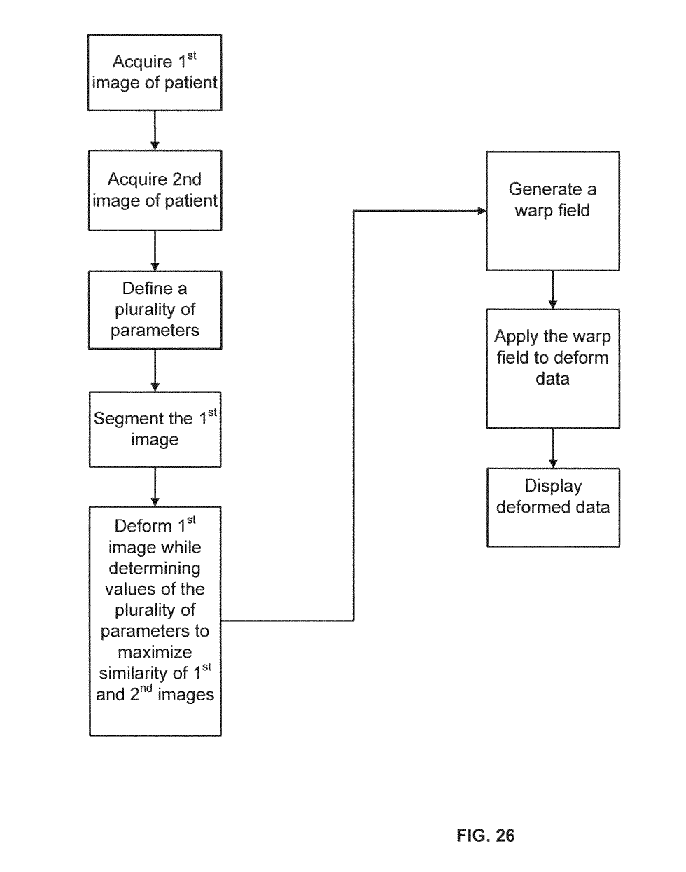

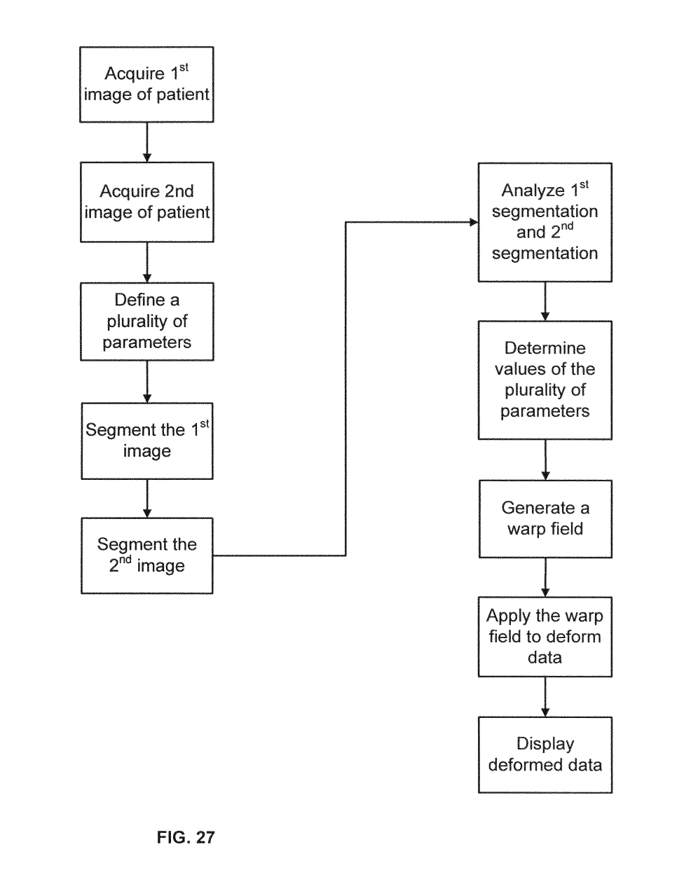

To obtain qualitative results, we generated animations that warp the daily image to the planning image gradually by stepping along the deformation field. ADD produced movies that are noticeably more visually pleasing, owing to the anatomic integrity of the recovered motion. FIG. 25 presents the first and last frames.

Various features and advantages of the invention are set forth in the following claims.

What is claimed is:

1. A system for presenting data relating to a radiation therapy treatment plan for a patient, the system comprising:
a computer having a computer operable medium including instructions that cause the computer to:
acquire a first image of a patient and a second image of the patient, the first image and the second image including a plurality of voxels;
define a plurality of parameters related to anatomically allowable motion of the voxels;
segment the first image to obtain a first segmentation identifying each voxel in the first image according to its tissue type;
generate a warp field based on the values of the plurality of parameters;
apply the warp field to deform data and to display the deformed data; and
adjust the warp field by interactively instructing the computer to adjust at least one of the values of the plurality of the parameters.

2. A method of generating a warp field to deform an image, the method comprising using a computer to:
acquire a first image of a patient and a second image of the patient, the first image and the second image including a plurality of voxels;
define a plurality of parameters related to anatomically allowable motion of the voxels;
segment the first image to obtain a first segmentation identifying at least one voxel in the first image according to its tissue type;
segment the second image to obtain a second segmentation identifying at least one voxel in the second image according to its tissue type;
analyze the first segmentation and the second segmentation to determine values of the plurality of parameters;
generate a warp field based on the values of the plurality of parameters; and
apply the warp field to deform data.

3. The method of claim 2 wherein the data is one of the first image and the second image.

4. The method of claim 2 wherein the data is one of a contour on one of the first image and the second image.

5. The method of claim 2 wherein the data is dosimetric data.

6. The method of claim 2 wherein the data is a third image different than the first image and the second image.

7. The method of claim 6, wherein the third image is one of a MRI image and a PET image.

8. The method of claim 2 further comprising generate an anatomical atlas based on the first segmentation, and apply the atlas to the second image during the segmentation of the second image.

9. The method of claim 2 wherein the tissue type is one of bone, air and soft tissue.

10. The method of claim 9 wherein bone as the tissue type is further identified by at least one specific bone within the human skeleton.

11. The method of claim 10 wherein at least one of the specific bones is further identified by an anatomically defined portion of the specific bone.

12. The method of claim 9 wherein soft tissue as the tissue type is further identified as one of fat and muscle.

13. The method of claim 12 wherein the soft tissue as the tissue type is further identified as an organ.

14. The method of claim 2 further comprising selecting the voxels in the first segmentation and the second segmentation having a first tissue type to deform one of the first image and the second image based on the selected first tissue type, and selecting the voxels in the first segmentation and the second segmentation having a second tissue type to deform one of the first image and the second image based on the selected second tissue type.

15. The method of claim 14 wherein the first tissue type is bone and the second tissue type is skin.

16. The method of claim 2 wherein generating the warp field includes selecting a plurality of the voxels in the first segmentation and the second segmentation to remain rigid while moving a plurality of unselected voxels in the first segmentation and the second segmentation relative to the selected voxels.

17. The method of claim 2 wherein generating the warp field includes maintaining a relationship between voxels within a selected set of voxels.

18. The method of claim 2 wherein one of the plurality of parameters includes skeletal motions.

19. The method of claim 18 wherein skeletal motion includes one of tilt, swivel, nod, swing, scrunch, rotation, twist, and kink.

20. The method of claim 18 wherein skeletal motion includes one of head tilt, head swivel, head nod, mandible swing, shoulder tilt, and shoulder scrunch.

21. The method of claim 2 wherein one of the plurality of parameters includes weight loss.

22. The method of claim 2 wherein one of the plurality of parameters includes breathing phase.

23. The method of claim 2 wherein one or more of the plurality of parameters includes organ expansion and retraction.

24. The method of claim 23 wherein organ expansion and retraction includes bladder inflation.

25. The method of claim 2 wherein segmenting one of the first image and the second image includes inputting a previously segmented image from an external source.

26. The method of claim 2 further comprising initialize a free-form deformation process based on the warp field.

27. The method of claim 2 further comprising display the deformed data.

28. The method of claim 2 wherein generating the warp field is further based on at least one patient image.

29. The method of claim 2 wherein generating the warp field is further based on enforcing consistency information in patient images acquired during a plurality of treatments.

30. The method of claim 2 wherein generating the warp field is further based on cohort data acquired from a plurality of patients.

31. The method of claim 2 wherein generating the warp field is further based on patient-specific information.

32. The method of claim 2 wherein the plurality of parameters are defined based on a location of a target on the patient.

33. A method of generating a warp field to deform an image, the method comprising:
acquiring a first image of a patient and a second image of the patient, the first image and the second image including a plurality of voxels;
defining a plurality of parameters related to anatomically allowable motion of the voxels;
segmenting the first image to obtain a first segmentation identifying at least one voxel in the first image according to its tissue type;
determining the plurality of parameter values to maximize a similarity of the first and second images wherein the first image is deformed while the plurality of parameter values are being determined;
generating a warp field based on the values of the plurality of parameters; and
applying the warp field to deform data.

34. The method of claim 33 further comprising generating a similarity measure of the deformed first image and the second image.

35. The method of claim 34 wherein the similarity measure is one of Mutual Information, normalized mutual information, cross-correlation, and a sum of squared differences combined with histogram equalization.

36. The method of claim 34 wherein the optimizing step is iterated by adjusting the plurality of parameter values until the similarity measure is maximized.

37. The method of claim 33 wherein the plurality of parameter values are optimized using one of conjugate gradient, Levenburg-Marquardt, simplex method, 1+1 evolution, and brute force.

38. The method of claim 33 wherein the plurality of parameter values are optimized using Powell's method.

39. The method of claim 33 wherein the data is the first image.

40. The method of claim 33 wherein the data is a contour on the first image.

41. The method of claim 33 wherein the data is dosimetric data.

42. The method of claim 33 wherein the data is a second image different than the first image.

43. The method of claim 42, wherein the second image is one of a MRI image and a PET image.

44. The method of claim 33 wherein the tissue type is one of bone, air and soft tissue.

45. The method of claim 44 wherein bone as the tissue type is further identified by at least one specific bone within the human skeleton.

46. The method of claim 45 wherein at least one of the specific bones is further identified by an anatomically defined portion of the specific bone.

47. The method of claim 44 wherein soft tissue as the tissue type is further identified as one of fat and muscle.

48. The method of claim 47 wherein the soft tissue as the tissue type is further identified as an organ.

49. The method of claim 33 further comprising selecting the voxels in the first segmentation having a first tissue type to deform one of the first image and the second image based on the selected first tissue type, and selecting the voxels in the first segmentation having a second tissue type to deform one of the first image and the second image based on the selected second tissue type.

50. The method of claim 49 wherein the first tissue type is bone and the second tissue type is skin.

51. The method of claim 33 wherein generating the warp field includes selecting a plurality of the voxels in the first segmentation to remain rigid while moving a plurality of unselected voxels in the first segmentation relative to the selected voxels.

52. The method of claim 33 wherein generating the warp field includes maintaining a relationship between voxels within a selected set of voxels.

53. The method of claim 33 wherein one of the plurality of parameters includes skeletal motions.

54. The method of claim 53 wherein skeletal motion includes one of tilt, swivel, nod, swing, scrunch, rotation, twist, and kink.

55. The method of claim 53 wherein skeletal motion includes one of head tilt, head swivel, head nod, mandible swing, shoulder tilt, and shoulder scrunch.

56. The method of claim 33 wherein one of the plurality of parameters includes weight loss.

57. The method of claim 33 wherein one of the plurality of parameters includes breathing phase.

58. The method of claim 33 wherein one or more of the plurality of parameters includes organ expansion and retraction.

59. The method of claim 58 wherein organ expansion and retraction includes bladder inflation.

60. The method of claim 33 wherein segmenting the first image includes inputting a previously segmented image from an external source.

61. The method of claim 33 further comprising initialize a free-form deformation process based on the warp field.

62. The method of claim 33 further comprising display the deformed data.

63. The method of claim 33 wherein generating the warp field is further based on at least one patient image.

64. The method of claim 33 wherein generating the warp field is further based on enforcing consistency information in patient images acquired during a plurality of treatments.

65. The method of claim 33 wherein generating the warp field is further based on cohort data acquired from a plurality of patients.

66. The method of claim 33 wherein generating the warp field is further based on patient-specific information.

67. The method of claim 33 wherein the plurality of parameters are defined based on a location of a target on the patient.
